(19) United States
(12) Patent Application Publication
(10) Pub. No.: US 2015/0319921 A1
(43) Pub. Date: Nov. 12, 2015

(54) CYLINDER MOWER BEDBAR ASSEMBLY

(71) Applicant: Textron, Inc., Providence, RI (US)

(72) Inventors: Robert James Pilon, JR., Huntersville, NC (US); Richard Michael Krzesicki, Charlotte, NC (US)

(73) Assignee: Textron, Inc., Providence, RI (US)

(21) Appl. No.: 14/271,516

(22) Filed: May 7, 2014

(51) Int. Cl. A01D 34/62

(52) U.S. Cl. CPC A01D 34/62

(57) ABSTRACT

In various embodiments, the present disclosure provides a multi-piece bedbar assembly for cylinder mower. The multi-piece bedbar assembly generally includes a bedbar comprising an elongated metal structure having a back, a bottom, and a face disposed between the back and the bottom. The bedbar assembly additionally includes a pair of adjustment arms that are separate and distinct from the bedbar and are connectable to the bedbar back.

### FIELD

The present teachings relate to cylindrical mowers, and more particularly to a multi-piece bedbar assembly for cylinder mowers.

### BACKGROUND

The statements in this section merely provide background information related to the present disclosure and may not constitute prior art.

Reel mowers, commonly used for cutting, grooming and maintaining grass at golf courses, sporting venues, parks, consumer lawns, etc., include one or more reel assemblies that are pushed or pulled by a motorized propulsion system, e.g., self-propelled walk behind reel mowers or multi-reel assembly riding mowers. Generally, each reel assembly includes a blade cylinder comprising a plurality of cutting blades helically disposed about a shaft that is rotationally mounted within a frame, and a bedknife comprising a bedknife blade mounted to a bedbar that is adjustably connected to the frame. In operation the blade cylinder is rotated about the shaft such that the blades rotate past, and contact the bedknife blade in a scissor-like manner, thereby cutting any blade of grass that comes between the cylinder blades and the bedknife blade.

Known bedbars are single piece cast iron structures that include a main body, to which the bedknife blade is connected, and a pair of mounting arms that are integrally formed with and extend from the main body. The current casting method of one piece, unitary structure, bedbars is very challenging due to the required geometry of the bedbar, quality fall out and the repeatability of the process.

### SUMMARY

In various embodiments, the present disclosure provides a multi-piece bedbar assembly for cylinder mower. The multi-piece, or multi-component, bedbar assembly generally includes a bedbar comprising an elongated metal structure having a back, a bottom, and a face disposed between the back and the bottom. The bedbar assembly additionally includes a pair of adjustment arms that are separate and distinct from the bedbar and are connectable to the bedbar back.

In various other embodiments, the present disclosure provides a bedknife assembly for a cylinder mower, wherein the bedknife assembly includes a multi-piece, or multi-component, bedbar assembly and an elongated knife blade that is connectable the bedbar assembly. The multi-piece bedbar assembly generally comprises a bedbar that is cut from a longer piece of metal stock, e.g., a piece extruded metal stock, and a pair of adjustment arms that are separate and distinct from the bedbar and are connectable to a back of bedbar.

In still other embodiments, the present disclosure provides a method of manufacturing a multi-piece, or multi-component, bedbar assembly for a cylinder mower. Generally, the method comprises cutting an extruded metal structure to a particular length to provide bedbar having a back, a bottom, and a face disposed between the back and the bottom. The method further includes attaching a pair of adjustment arms that are separate and distinct from the bedbar to the bedbar back.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is an exploded view of a cylinder mower reel assembly including the multi-piece bedbar assembly, in accordance with various embodiments of the present disclosure.

FIG. 2 is an exploded front view of the multi-piece bedbar assembly shown in FIG. 1, in accordance with various embodiments of the present disclosure.

FIG. 3 is a partially exploded rear view of the multi-piece bedbar assembly shown in FIGS. 1 and 2, in accordance with various embodiments of the present disclosure.

FIG. 4 is an assembled top view of the of the multi-piece bedbar assembly shown in FIGS. 1, 2 and 3, in accordance with various embodiments of the present disclosure.

FIG. 5 is an exploded view of a bedknife assembly including the multi-piece bedbar assembly shown in FIGS. 1, 2, 3 and 4, in accordance with various embodiments of the present disclosure.

FIG. 6 is a flow chart illustrating a fabrication or manufacturing process or method for the multi-piece bedbar assembly shown in FIGS. 1, 2, 3, 4 and 5, in accordance with various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements.

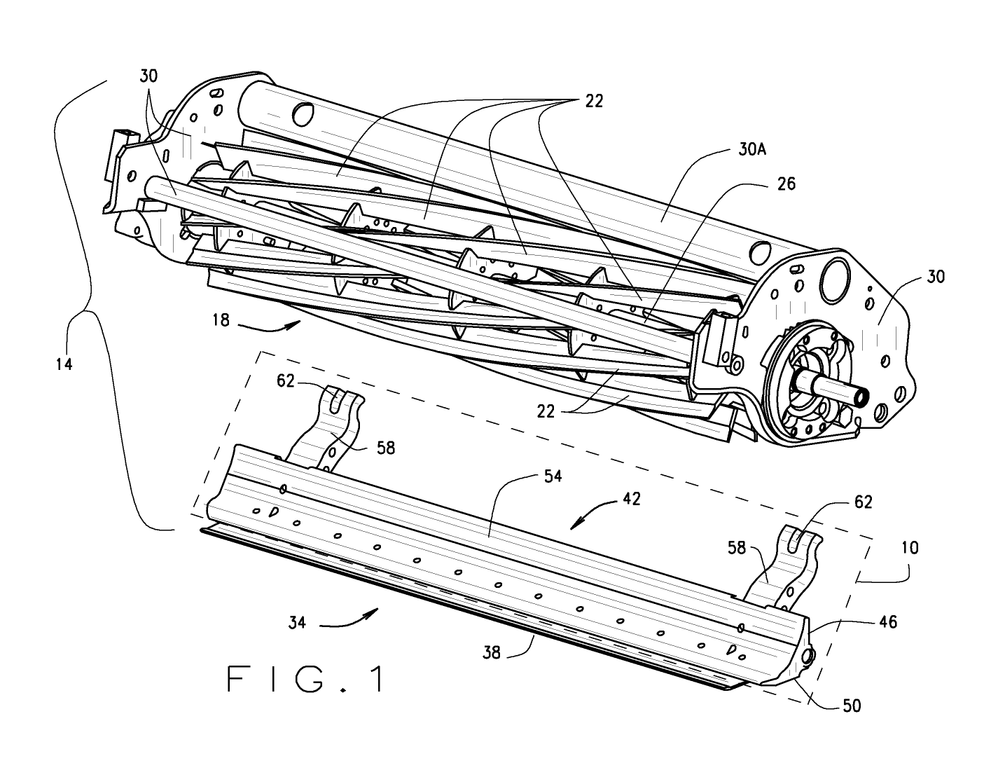

Referring to FIG. 1, the present disclosure provides a multi-piece, or multi-component, bedbar assembly 10 for a reel assembly 14 of cylinder mower. As exemplarily illustrated in FIG. 1, in various embodiments, the reel assembly 14 includes a blade cylinder 18 comprising a plurality of cutting blades 22 helically disposed about a shaft 26 that is rotationally mounted within a reel frame 30. The reel assembly 14 additionally includes a bedknife assembly 34 that comprises a bedknife blade 38 mounted to the multi-piece bedbar assembly 10. As described further below, the bedknife assembly 34 is adjustably connectable to the reel frame 30, and more particularly to a bedknife mounting brace 30A of the reel frame 30. Generally, in operation the blade cylinder 18 is rotated, via a motor or other drive device (not shown) connected to the shaft 26 such that the blades 22 rotate past, and contact the bedknife blade 38 in a scissor-like manner, thereby cutting any blade of grass caught between the cylinder blades 22 and the bedknife blade 38 as the reel assembly 14 is moved across the ground via a mower propulsion system (i.e., walk-behind cylinder mowers) or vehicle (i.e., riding cylinder mowers).

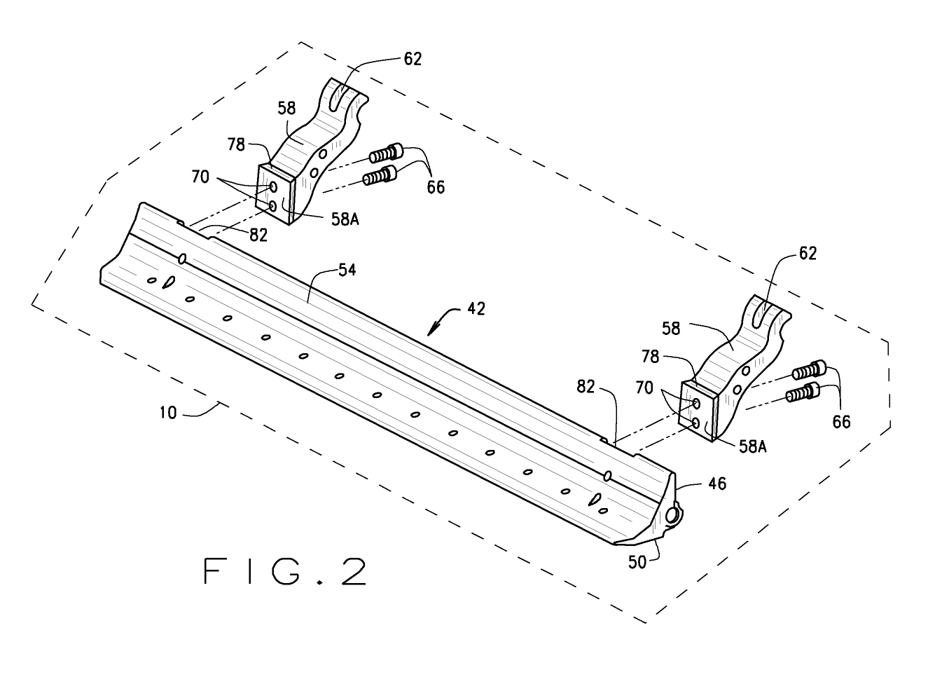

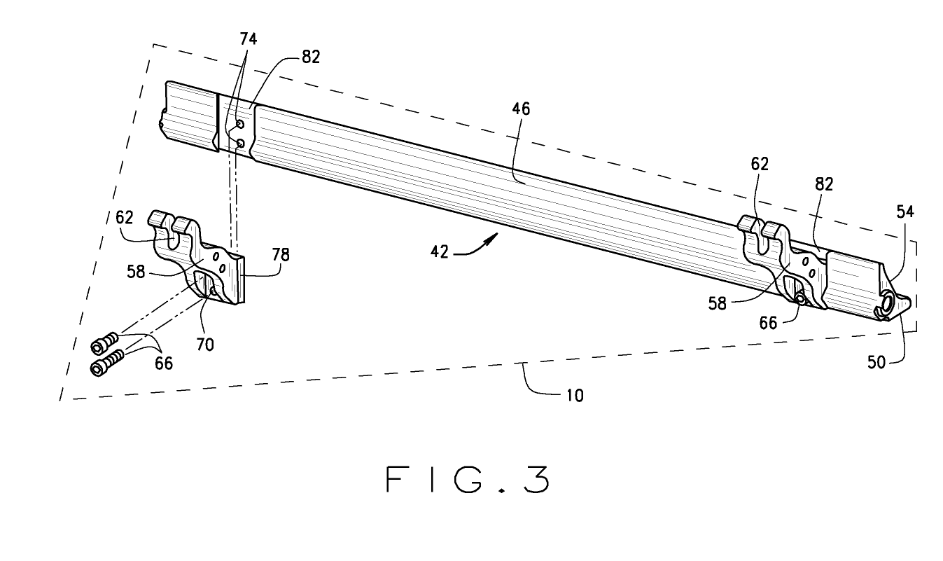

Referring now to FIGS. 2 and 3, the multi-piece/component bedbar assembly 10 of the present disclosure includes a bedbar 42 comprising an elongated metal structure having a back 46, a bottom 50, and a face 54 disposed between the back 46 and the bottom 50. The bedbar assembly 10 additionally includes a pair of adjustment arms 58 that are independent, separate and distinct structures from the bedbar 42 and are connectable to the bedbar back 46 using any suitable connection means and/or manner. The bedbar 42 is an independent structure, separate and apart from the adjustment arms 58, and can be fabricated of any suitable material, e.g., carbon steel, aluminum, stainless steel, plastic, nylon, or any composite thereof, using any suitable fabrication process, e.g., extrusion, molding, etc. For example, in various embodiments, the bedbar 42 can be fabricated of a carbon steel material using an extrusion process. In such embodiments, longer lengths of extruded carbon steal, having a desired bedbar cross-sectional profile throughout the length thereof, can be cut into shorter lengths, e.g., 18″, 22″, 26″, etc. to provide the bedbar 42 having a particular length specific to the reel assembly 14 for which it is to be utilized.

The cross-sectional profile of the bedbar 42 is designed to provide desired features and functionality of the bedbar 42. For example, the cross-sectional profile of the bedbar 42 is designed such that the face 54 provides a desired grass cutting flow and/or discharge specific to the respective application, and the back 46 and bottom 50 have lengths and shapes designed to provide a desired strength and rididity across the span of the bedbar 10 that is specific to the respective application. Importantly, by fabricating the bedbar 10 as an independent structure, separate and apart from the adjustment arms 58, e.g., via extrusion, various bedbars 42 having different cross-sectional profiles can be easily fabricated to provide various bedbar functionality specific to the respective application.

As described above, the adjustment arms 58 are fabricated as independent, separate and distinct structures from the bedbar 42, and are connectable to the bedbar 42 subsequent to the fabrication of bedbar 42. The adjustment arms 58 can be fabricated using any suitable fabrication process, e.g., molded, milled, forged, etc. Generally, the adjustment arms 58 are adjustably mountable to the mounting brace 30A of the reel frame 30 via a slotted mounting aperture or opening 62 formed at a distal end of the adjustment arms 58, and are fixedly connectable, mountable or attachable to the bedbar 42 via any suitable connecting, mounting or attaching means, e.g., bolted, screwed, riveted, welded, glued, etc. at an opposing proximal end of the adjustment arms 58. For example, in various embodiments, the adjustment arms 58 can be fixedly connected and secured to the back 46 of the bedbar 42 via bolts 66, through holes 70 formed in the proximal ends of the adjustment arms 58, and threaded bores 74 provided in the bedbar 42.

In further embodiments, each adjustment arm 58 can further include a bedbar connection fixture 78 formed at the proximal end thereof that is structured and operable to be received within a respective one of a pair of mounting recesses 82 formed, e.g., milled or cut, into the back 46 of the bedbar 42. The mounting recesses 82 are sized and shaped to tightly mate with the connection fixtures 78 to provide additional stability, strength, rigidity and fixation to the connection between the adjustment arms 58 and the bedbar 42. Accordingly, to connect the adjustment arms 58 to the bedbar 42 in such embodiments, the connection fixture 78 of each adjustment arm 58 is mated within a respective one of the mounting recesses 82, whereafter the proximal ends of the adjustment arms 58 are fixedly connected and secured to the bedbar 42 via the bolts 66, or any suitable connection means, e.g., screws, rivets, welding, glue, etc.

The adjustment arms 58 can be of any length, shape and contour suitable for the respective application and corresponding architecture and structure of the reel frame 30. Moreover, by fabricating the bedbar 10 as an independent structure, separate and apart from the adjustment arms 58, e.g., via extrusion, the adjustment arms 58 are interchangeable such that bedbar assembly 10 can be configured to utilize any desired length, shape and contour of adjustment arms 58 with any respective independent and separate bedbar 42.

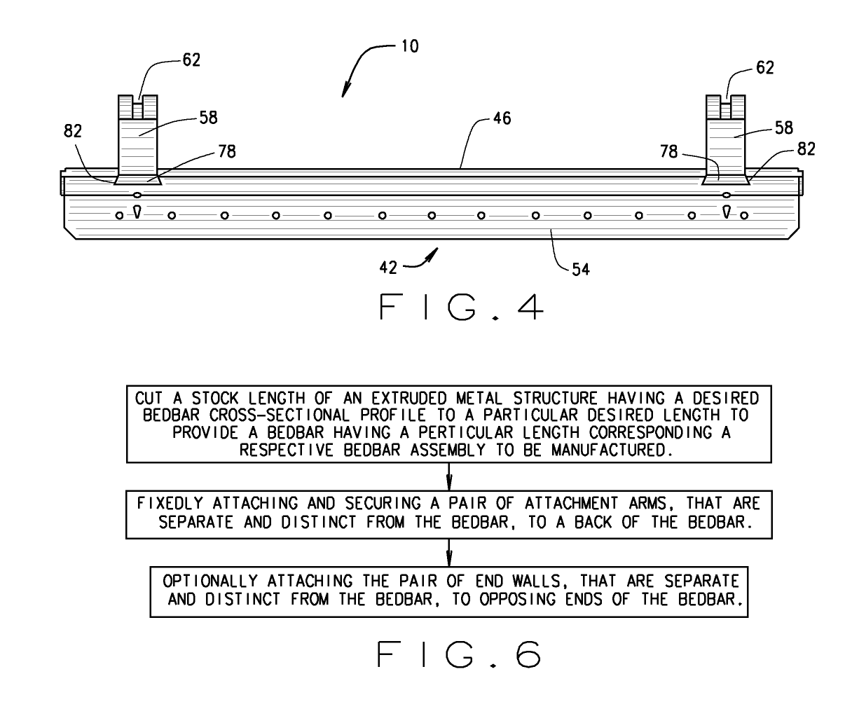

Referring now to FIGS. 2, 3 and 4, in various embodiments, the bedbar mounting recesses 82 can be formed to provide a female portion of a dovetail connection. That is, as most clearly illustrated in FIG. 4, the mounting recesses 82 are formed such that sidewalls of each mounting recess 82 are angle outward as they extend from the bedbar back 46 internally toward the bedbar face 54. Additionally, in such embodiments, the adjustment arm connection fixtures 78 are formed to provide a male portion of the dovetail connection. That is, as most clearly illustrated in FIG. 4, the connection fixtures 78 are formed such that sidewalls of each mounting fixture 78 are angle inward as they extend from a proximal end face 58A (shown best in FIG. 2) toward the opposing distal end including the mounting slots/apertures 62. Moreover, the dovetail connection female portion provided by the bedbar mounting recesses 82 are sized and shaped to tightly mate with the dovetail connection male portion provided by the connection fixtures 78 of the adjustment arms 58, whereby the adjustment arms 58 can be connected and secured to the bedbar 42.

Accordingly, to connect the adjustment arms 58 to the bedbar 42 in such embodiments, the male dovetail connection fixture 78 of each adjustment arm 58 is slidingly engaged and mated within a respective one of the female dovetail mounting recesses 82, whereby the geometry of the formed dovetail connection substantially rigidly retains the connection fixtures 78 within the mounting recesses 82. Thereafter, the connection fixtures 78 are fixed and secured within the mounting recesses 82 such that the adjustment arms 58 are fixedly connected and secured to the bedbar 42 via the bolts 66, or any suitable connection means, e.g., screws, rivets, welding, glue, etc.

Referring now to FIG. 5, in various embodiments, the bedbar assembly 10 can further include a pair of end walls 86 that are affixed to the opposing ends of the bedbar 42. In various implementations, the end walls 86 can be affixed to opposing ends of the face 54 of the bedbar 42. The end walls 86 can be affixed to the bedbar in any suitable manner. For example, in various implementations, the bedbar face 54 can include reservoirs 90 that are formed in the opposing ends of the face 54. The reservoirs 90 are sized and shaped to receive and mate with the end walls 86, such that the end walls 86 can be disposed within the reservoirs 90 and subsequently glued, welded, screwed, or secured to the bedbar 42 in any other suitable manner. The end walls 86 can be fabrication of any suitable material such as carbon steel, aluminum, stainless steel, plastic, nylon, or any composite thereof.

Referring now to FIGS. 1 and 5, as described above, in various other embodiments, the bedbar assembly 10 can be part of the bedknife assembly 34, wherein the bedknife assembly 34 includes the elongated bedknife blade 38 mounted to the bottom 50 of the bedbar 42. The bedknife blade 38 can be fixedly mounted and secured to the bedbar bottom 50 utilizing any suitable affixation method or means. For example, in various embodiments, the bedknife blade 38 can be screwed to the bottom 50 of the bedbar 42. In such embodiments the bedbar 42 includes a plurality of threaded holes 94 disposed in the bedbar bottom 50. The thread holes 94 can extend through to the face 54 of the bedbar 42, as exemplarily illustrated in FIG. 5, or the threaded holes 94 can end internally of the bedbar 42. Additionally, in such embodiments, the bedknife blade 38 includes a plurality of holes 98 through which a plurality of screws 102 can be passed and threaded into the thread holes 94 to fixedly secure the bedknife blade 38 to the bottom 50 of the bedbar 42. Alternatively, it is envisioned that the bedknife blade 38 can be fixedly secured to the bedbar 42 via welding, riveting, or any other suitable fixation means or method.

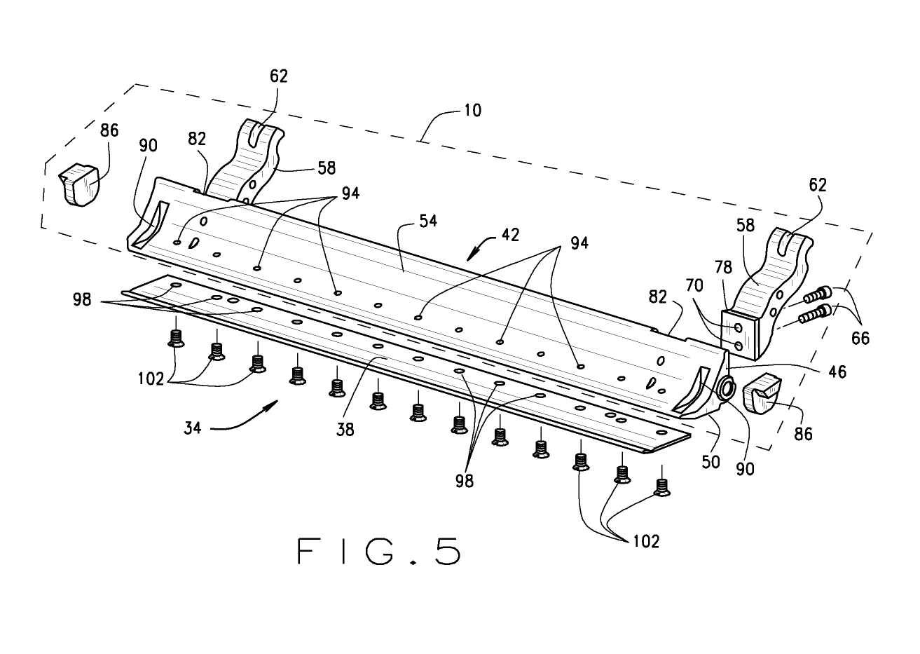

FIG. 6 provides a flow chart 200 illustrating a fabrication or manufacturing process or method for the bedbar assembly 10, in accordance with various embodiments of the present disclosure. Initially, a stock length of an extruded metal structure (e.g., an extruded carbon steel structure) having a desired bedbar cross-sectional profile is cut to a particular desired length (e.g., 18″, 22″, 26″, etc.) to provide the bedbar 42 having a particular length corresponding the respective bedbar assembly 10 to be manufactured, as illustrated at 202. As described above, the stock length, and hence the bedbar 46, comprises the back 49, bottom 50, and face 54 that each have a desired length and contour to provide the desired cross-sectional profile corresponding to the respective bedbar assembly 10 to be manufactured. Next, the pair of attachment arms 58, that are separate and distinct from the bedbar 42, are fixedly attached and secured to the back 46 of the bedbar 42, as illustrated at 204. As described above, the attachment arms 58 can be fixedly attached and secured to the bedbar back 46 using any suitable means or method. For example, the attachment arms 58 can be fixedly attached and secured to the bedbar back 46 via the dovetail connection described above.

In various embodiments, the method/process can further include attaching the pair of end walls 86, that are separate and distinct from the bedbar 42, to opposing ends of the bedbar 42, as indicated at 206. Subsequent, to construct the bedknife assembly 34, the elongated bedknife blade 38 can be fixedly attached to the bottom 50 of the bedbar 42, as described above.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A bedbar assembly for cylinder mower, said assembly comprising:
a bedbar comprising an elongated metal structure having a back, a bottom, and a face disposed between the back and the bottom; and
a pair of adjustment arms that are separate and distinct from the bedbar and are connectable to the bedbar back.

2. The assembly of claim 1, wherein the bedbar comprises an extruded metal structure.

3. The assembly of claim 1, wherein each adjustment arm comprises a connection fixture and the bedbar comprises a pair of mounting recesses formed in the back of the bedbar that are structured and operable to receive and mate with the adjustment arm connection fixtures for attaching the adjustment arms to the bedbar.

4. The assembly of claim 3, wherein the bedbar mounting recesses are formed to provide a female portion of a dovetail connection, and the adjustment arm connection fixtures are formed to provide a male portion of the dovetail connection, such that adjustment arms are attachable to the bedbar via the dovetail connection.

5. The assembly of claim 1 further comprising a pair of end walls that are separate and distinct from the bedbar and are connectable to opposing ends of the bedbar.

6. A bedknife assembly for a cylinder mower, said bedknife assembly comprising:
a bedbar assembly comprising:
a bedbar comprising an elongated metal structure having a back, a bottom, and a face disposed between the back and the bottom; and
a pair of adjustment arms that are separate and distinct from the bedbar and are connectable to the bedbar back; and
an elongated knife blade that is connectable to the bedbar bottom.

7. The assembly of claim 6, wherein the bedbar comprises an extruded metal structure.

8. The assembly of claim 6, wherein each adjustment arm comprises a connection fixture and the bedbar comprises a pair of mounting recesses formed in the back of the bedbar that are structured and operable to receive and mate with the adjustment arm connection fixtures for attaching the adjustment arms to the bedbar.

9. The assembly of claim 8, wherein the bedbar mounting recesses are formed to provide a female portion of a dovetail connection, and the adjustment arm connection fixtures are formed to provide a male portion of the dovetail connection, such that adjustment arms are attachable to the bedbar via the dovetail connection.

10. The assembly of claim 6, wherein the bedknife assembly further comprises a pair of end walls that are separate and distinct from the bedbar and are connectable to opposing ends of the bedbar.

11. A method of manufacturing a bedbar assembly for a cylinder mower, said method comprising:
cutting an extruded metal structure to a particular length to provide bedbar having a back, a bottom, and a face disposed between the back and the bottom; and
attaching a pair of adjustment arms that are separate and distinct from the bedbar to the bedbar back.

12. The method of claim 11 further comprising forming a pair of adjustment arm mounting recesses in the back of the bedbar.

13. The method of claim 12, wherein attaching the adjustment arms to the bedbar back comprises:
inserting a connection fixture of each adjustment arm into a respective one of the mounting recesses such that the connection fixtures mate with the mounting recesses; and
subsequently fixedly attaching the adjustment arms to the bedbar back such that the connection fixtures are retained within the mounting recesses.

14. The method of claim 12, wherein forming the pair of adjustment arm mounting recesses comprises forming a pair of dovetail recesses in the bedbar back to provide female portions of a pair of dovetail connections, and
wherein attaching the adjustment arms to the bedbar back comprises:
inserting a connection fixture of each adjustment arm, formed to provide a male portion of the dovetail connections, into a respective one of the dovetail mounting recesses such that dovetail connections of the connection fixtures with the mounting recesses are formed; and
subsequently fixedly attaching the adjustment arms to the bedbar back such that the dovetail connection fixtures are retained within the dovetail mounting recesses.

15. The method of claim 11 further comprising a connecting a pair of end walls that are separate and distinct from the bedbar to opposing ends of the bedbar.
